(19) United States
(12) Patent Application Publication
(10) Pub. No.: US 2012/0316604 A1
(43) Pub. Date: Dec. 13, 2012

(54) Protective Covering Teether

(76) Inventors: Elizabeth Neely Thrush, Stevensville, MD (US); Jane Thrush, McHenry, MD (US); Benjamin Thrush, McHenry, MD (US)

(21) Appl. No.: 12/941,871

(22) Filed: Nov. 11, 2010

Related U.S. Application Data
(60) Provisional application No. 61/265,425, filed on Dec. 1, 2009.

(51) Int. Cl. A61J 17/02

(52) U.S. Cl. 606/235

(57) ABSTRACT

A protective covering teether comprising a portable protective cover and teether that slips over a surface to provide a safe, hygienic, and enjoyable surface for infants and babies to teeth, gum, and chew, in which the cover and teether keep the surface dry and clean, in which the cover and teether protect the surface from destruction and frequent cleaning due to mildew and mold growth, and in which the covering contains bumps, ridges, and nubs that are interesting to the infant and baby and orally soothing.

### BACKGROUND OF THE INVENTION

The disclosure generally relates to infant care devices, specifically portable covers and teethers.

Commonly, teething devices are constantly dropped, which leaves them soiled, lost, and often unused. Thus, there is a need for teething devices that not only hygienically protect babies, but are more convenient for baby and parental use.

The present disclosure provides a protective covering teether that includes, without limitation, a portable cover and appropriate teething device for babies since it can be used on multiple surfaces, protects surfaces with which babies make oral and tactile contact, stimulates creativity by providing interactive chewable bangle toys, and promotes good oral hygiene by protecting babies from germs and contaminants.

Further, the protective covering teether includes a tight-fitting gripping mechanism that ensures that the invention will not fall on the floor or be pulled off by a baby. Thus, negative hygiene issues resulting from the fallen device can be reduced or eliminated.

### BRIEF SUMMARY OF THE INVENTION

In accordance with the disclosure, the protective covering teether comprises a portable protective cover and teether that slips over a surface to provide a safe, hygienic, and enjoyable surface for infants to teeth, gum, and chew, wherein the portable cover and teether keep the surface dry and clean, wherein the cover and teether protect the surface from destruction and frequent cleaning due to mildew and mold growth, and wherein the covering contains bumps, ridges, and nubs that are interesting to the infant and orally soothing.

In another aspect of the disclosure, the teether is designed to fit multiple surfaces with which infants frequently have oral and tactile contact, including but not limited to front pack baby carriers, back pack baby carriers, high chairs, bucket swings, strollers, and table edges.

Other objects will be apparent from the following description of the drawings and embodiments of the invention.

### BRIEF DESCRIPTION OF THE DRAWINGS

FIG. 1 is a plain view of a protective covering teether of the invention attached to a front pack worn by a caregiver carrying an infant or toddler;

FIG. 2 is a front view of a portable protective covering teether of the invention;

FIG. 3 is a back view of a portable protective covering teether of the invention;

FIG. 4 is a cross section of a portable protective covering teether of the invention; and

FIG. 5 is a cross section of a portable protective covering teether of the invention clamped to a surface.

### DETAILED DESCRIPTION OF THE INVENTION

Detailed descriptions of the preferred embodiment are provided herein. It is understood that the present embodiment may be embodied in various forms. As a result, specific details disclosed herein are not to be interpreted as limiting, but rather as a representative basis for teaching one skilled in the art to employ the present invention in any appropriately detailed system, structure or manner.

The term “teether” generally relates to and is understood to mean a device for an infant to bite on while new teeth are breaking through the gums.

The term “infant” generally relates to and is understood to mean a child in its early years who is in the process of teething as new teeth are breaking through gums. Infant is used interchangeably with the terms “baby” and “toddler.”

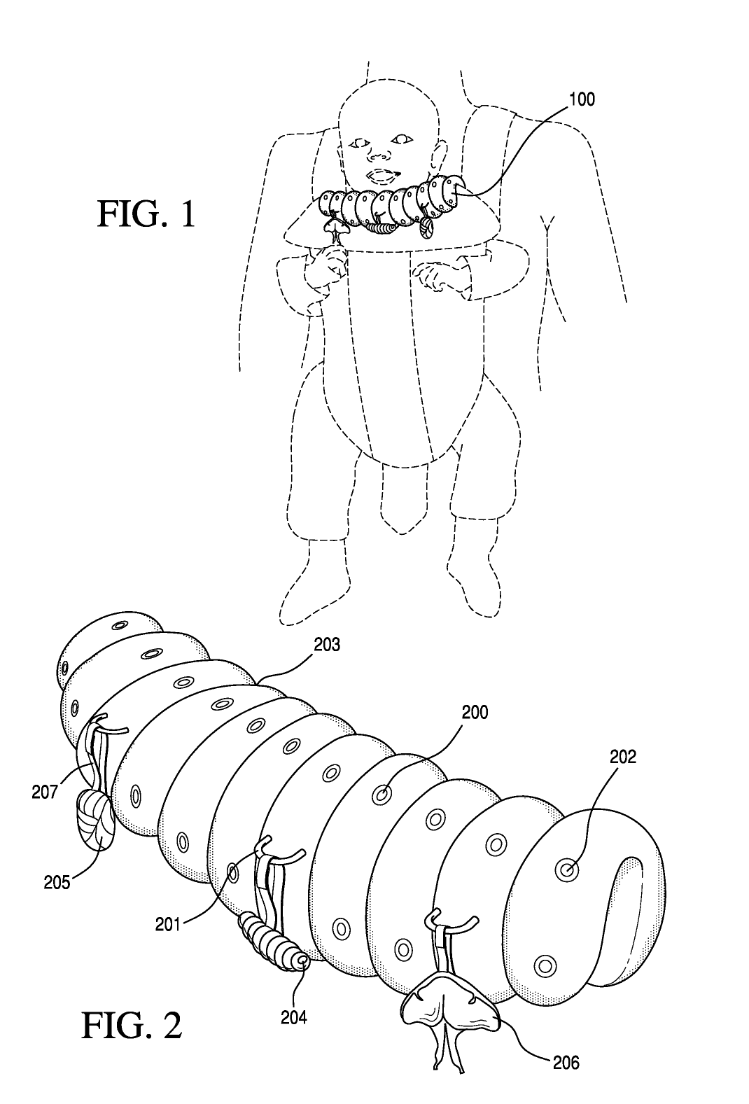

Referring now to the invention shown in FIG. 1, there is shown the portable cover and teether device 100 of a baby front pack cover.

In more detail, still referring to the invention of FIG. 1, there is shown the portable cover and teether device when it slips over the top of the front pack creating a comforting and hygienic place for baby to gum, chew, or suck.

In further detail, still referring to the invention of FIG. 1, the portable cover and teether device size and width of the protective portable covering teether will be modified for covers to fit table and other surfaces.

FIG. 2 illustrates the front view of a portable protective covering teether of the invention.

Referring to the invention in more detail, in FIG. 2 there is shown a front view portable cover and teether device having a teething nub 200 that is equally or randomly spaced across the portable cover and teether device. Nub shapes may be circular, oval, or linear shapes. Nub shapes may be equally spaced.

In more detail, still referring to the invention of FIG. 2 the protective portable cover and teether device have three attached bangle loops 201 which are holes or loops through which a bangle toy may be attached. The invention may contain one or more bangle loops or no bangle loops. Toys may attach by non-toxic cotton, rope, silicone, plastic, rubber, silicone rubber, cloth, wood, rubber wood, or fabric teether.

In more detail, still referring to the invention of FIG. 2 the portable cover and teether device has three decorative nubs 202 which mimic the eyes of a caterpillar for the amusement of the child. The invention may contain additional or fewer decorative nubs. The decorative nubs may also be in various shapes and designs.

In more detail, still referring to the invention of FIG. 2 the portable cover and teether device have three indentation lines 203 on the surface of the portable cover and teether device. The indentation lines 203 are decorative as well as soothing for gumming. The invention may contain one or more indentation lines or no indentation lines.

In further detail, still referring to the invention of FIG. 2 the portable cover and teether device may have a horizontal size between about six to about eight inches and a vertical size of between about three to about five inches.

Referring now to the invention shown in FIG. 2 there is shown bangle toys of multiple designs such as a caterpillar bangle toy 204, a cocoon bangle toy 205, and a butterfly/moth bangle toy 206 which are attached to loops or holes in the front of the portable cover and teether device. The bangle toy attachments may be made of other materials including but not limited to silicone, rubber, silicone rubber, plastic, cloth, fabric, rubberwood, or wood. The bangle toy attachments may be in various shapes and designs including but not limited to characters, animals, celestial bodies (sun, moon, stars, clouds), food, transportation (cars, trucks, trains), athletic equipment (balls, bats, gloves), dolls, flowers, objects of nature, or a combination thereof.

In more detail, still referring to the invention of FIG. 2, there is shown a bangle teether of multiple designs attached to the portable cover and teether device.

In further detail, still referring to the invention of FIG. 2, the bangle toys 204, 205, and 206 and the bangle teether will be attached to the portable cover and teether device by a Velcro fastener 207 of about one to about two inches in size. The fasteners may be in the form of but not limited to snaps, hooks, buttons, loops, or knots all of which may be made of materials including but not limited to plastic, cloth, metal, or fabric material.

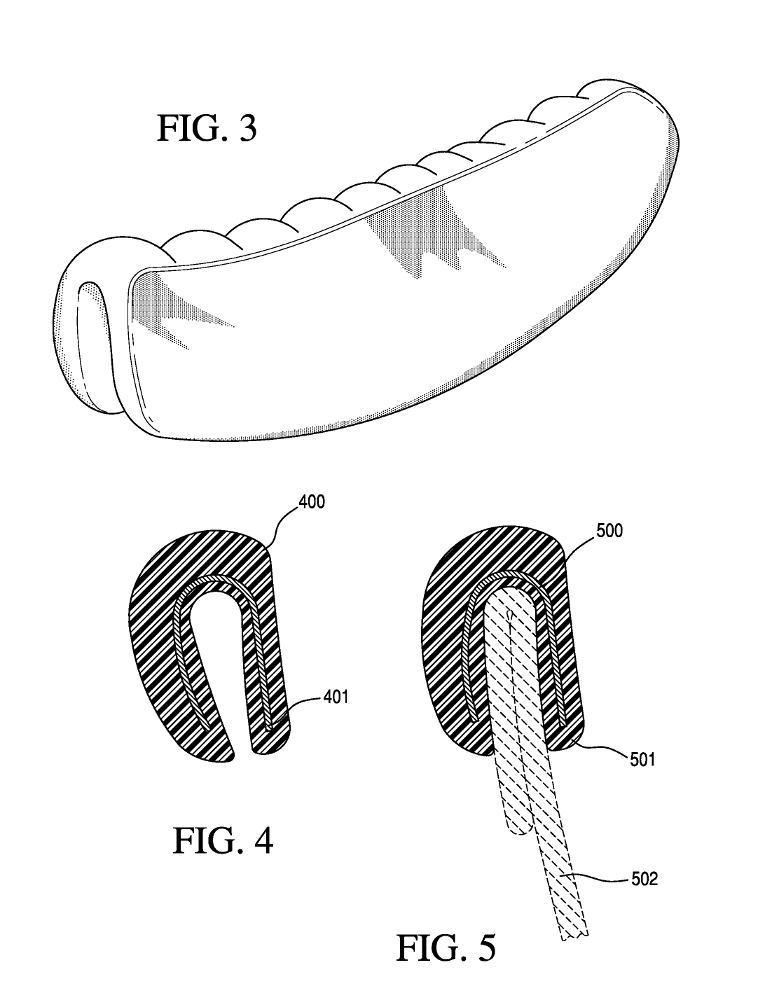

Referring now to the invention shown in FIG. 3 there is shown the back view of a portable cover and teether device.

The construction details of the invention as shown in FIG. 4, the portable cover and teether device is made of a silicone overlay 400. The overlay may also include a plastic core 401 encapsulated within the overlay. The overlay provides for a non-toxic teething and gumming surface. The overlay may be of other materials including but not limited to plastic, rubber, silicone rubber, cloth, wood, rubber wood, or fabric.

In further detail, still referring to the invention of FIG. 4 the portable cover and teether device side view may have a width size between about ⅛ to about ¼ inches.

The invention of FIG. 5 there is shown a portable side view of the cover and teether device having a molded plastic clamp 500 under silicone overlay 501. The plastic clamp is molded tightly to ensure a secure grasp of cover onto surface. The plastic clamp when pried open will have opposing force, thus providing constant grip. The silicone overlay provides for a non-toxic teething and gumming surface. The plastic clamp may be made of other materials including but not limited to silicone, rubber, silicone rubber, rubberwood, wood, or flexible metal.

Although the description above contains many specifications, these should not be construed as limiting the scope of the invention but as merely providing illustrations of some of the presently preferred embodiments of this invention.

Therefore, the invention should not be limited by the above described embodiment, method, and examples, but by all embodiments and methods within the scope and spirit of the invention.

What is claimed as new and desired to be protected by Letters Patent of the United States is:

1. A protective covering teether comprising:
a portable cover and teether that slip over a surface area to provide a safe and hygienic surface for infants and babies to teeth, gum, and chew,
wherein the portable cover and teether keep the surface dry and clean,
wherein the portable cover and teether protect the surface from destruction and frequent cleaning due to mildew and mold growth, and
wherein the portable cover comprises bumps, ridges, or nubs on a surface thereof.

2. The protective covering teether according to claim 1, wherein the portable cover and teether are made of an overlay.

3. The protective covering teether according to claim 2, wherein the overlay is made of a material comprising silicone, rubber, silicone rubber, plastic, cloth, fabric, rubberwood, wood, or a combination thereof.

4. The protective covering teether according to claim 2, wherein the portable cover and teether comprises a plastic core encapsulated within the overlay.

5. The protective covering teether according to claim 1, wherein the portable cover and teether comprise at least one teething nub that is equally or randomly spaced across the portable cover and teether device.

6. The protective covering teether according to claim 5, wherein the at least one teething nub comprises has a surface comprising circular, oval, or linear shapes that are equally or randomly spaced.

7. The protective covering teether according to claim 1, further comprising one or more indentation lines on a surface of the portable cover and teether.

8. The protective covering teether according to claim 1, wherein the teething device comprises a clamp made of plastic, silicone, rubber, silicone rubber, rubberwood, wood, flexible material, or a combination thereof.

9. The protective covering teether according to claim 1, further comprising one or more bangle loops.

10. The protective covering teether according to claim 8, wherein the one or more bangle loops comprises an object attached thereto.

11. The protective covering teether according to claim 8, wherein the object is an ornament or toy.

12. The protective covering teether according to claim 10, wherein the object is attached by non-toxic cotton, rope, silicone, plastic, rubber, silicone rubber, cloth, wood, rubber wood, fabric tether, or a combination thereof.

13. The protective covering teether according to claim 10, wherein the object is in the shape of characters, animals, celestial bodies, food, transportation, athletic equipment, dolls, flowers, objects of nature, or a combination thereof.

14. The protective covering teether according to claim 10, wherein the object is attached to the portable cover and teether device by a fastener made of Velcro, snaps, hooks, buttons, loops, knots, or a combination thereof.

15. The protective covering teether according to claim 14, wherein the fastener is made of plastic, cloth, metal, fabric material, or a combination thereof.

16. The protective covering teether according to claim 1, wherein the portable cover and teether are made of a silicone.

17. The protective covering teether according to claim 1, wherein the portable cover and teether have a size and width adapted for covers to fit table and other surfaces.

18. The protective covering teether according to claim 1, wherein the portable cover and teether slip over the top of a front pack or back pack creating a comforting and hygienic place for an infant or baby to gum, chew, or suck.
